(19) United States
(12) Patent Application Publication
(10) Pub. No.: US 2019/0130553 A1
(43) Pub. Date: May 2, 2019

(54) INFORMATION PROCESSING APPARATUS AND INFORMATION PROCESSING METHOD

(71) Applicant: CANON KABUSHIKI KAISHA, Tokyo (JP)

(72) Inventors: Nobuhito Suehira, Tokyo (JP); Yukio Furukawa, Sagamihara-shi (JP); Shuhei Toba, Kawasaki-shi (JP)

(21) Appl. No.: 16/171,604

(22) Filed: Oct. 26, 2018

(30) Foreign Application Priority Data
Nov. 2, 2017 (JP) 2017-212930

(51) Int. Cl. G06T 7/00; G06T 7/11

(52) U.S. Cl. CPC G06T 7/0002; G06T 2207/20221; G06T 2207/10132; G06T 7/11

(57) ABSTRACT

An information processing apparatus includes: a signal acquiring unit configured to acquire a photoacoustic signal, which has been obtained based on an acoustic wave generated from an object by irradiating light to different positions on the object for a plurality of times; a region setting unit configured to set a first region and a second region inside the object, based on a distance from a position at which a light axis of the light intersects with the object; and a generating unit configured to generate a first reconstructed image by using a photoacoustic signal corresponding to an acoustic wave generated from the first region, and to generate a second reconstructed image by using a photoacoustic signal corresponding to an acoustic wave generated from the second region.

### BACKGROUND OF THE INVENTION

### Field of the Invention

The present invention relates to an apparatus that processes an image including object information.

### Description of the Related Art

Photoacoustic imaging is known as a technique to image structural information and biological information (that is, functional information) inside an object.

When light, such as laser light, is irradiated to a living body, which is an object, an acoustic wave (typically an ultrasonic wave) is generated when the light is absorbed by a biological tissue inside the object. This phenomenon is called the “photoacoustic effect”, and the acoustic wave generated by the photoacoustic effect is called the “photoacoustic wave”. The absorption rate of the energy differs depending on the tissue constituting the object, hence the sound pressure of the generated photoacoustic wave is also different depending on the tissue. With PAT, a generated photoacoustic wave is received by a probe, and the received signal is mathematically analyzed, whereby characteristic information inside the object can be acquired.

Research on acquiring the object information at high speed and high precision by using photoacoustic techniques is ongoing. For example, Japanese Patent Application Publication No. 2014-113466 discloses a technique that acquires light intensity distribution in an object when light is irradiated on the object, and generates a photoacoustic image of a region in which light intensity is at least a threshold. According to this method, an image can be generated more quickly since the range of reconstructing the image is limited.

### SUMMARY OF THE INVENTION

In a general photoacoustic apparatus, a region on which light is irradiated and a region of which image is reconstructed are approximately the same. This is because a stronger photoacoustic wave is generated and more accurate object information can be acquired as the intensity of irradiated light is stronger.

On the other hand, if a light absorber exists near the surface of a living body, which is an object, the strong acoustic wave generated near the surface is reflected and scattered inside the object, which in some cases interrupts observation of a light absorber existing in a deep region. For example, an artifact may be generated in a deep region of the object by the reflected acoustic wave, making it impossible to perform accurate diagnosis.

With the foregoing problem of the prior art in view, it is an object of the present invention to reduce the noise superimposed on the object information in a photoacoustic image.

In order to solve the aforementioned problem, the information processing apparatus according to the present invention includes: a signal acquiring unit configured to acquire a photoacoustic signal, which has been obtained based on an acoustic wave generated from an object by irradiating light to different positions on the object for a plurality of times; a region setting unit configured to set a first region and a second region inside the object, based on a distance from a position at which a light axis of the light intersects with the object; and a generating unit configured to generate a first reconstructed image by using a photoacoustic signal corresponding to an acoustic wave generated from the first region, and to generate a second reconstructed image by using a photoacoustic signal corresponding to an acoustic wave generated from the second region.

In addition, the information processing method according to the present invention includes: a signal acquiring step of acquiring a photoacoustic signal, which has been obtained based on an acoustic wave generated from an object by irradiating light to different positions on the object for a plurality of times; a region setting step of setting a first region and a second region inside the object based on a distance from a position at which a light axis of the light intersects with the object; and a generating step of generating a first reconstructed image by using a photoacoustic signal corresponding to an acoustic wave generated from the first region, and generating a second reconstructed image by using a photoacoustic signal corresponding to an acoustic wave generated from the second region.

According to the present invention, the noise superimposed on the object information can be reduced in a photoacoustic image.

Further features of the present invention will become apparent from the following description of exemplary embodiments with reference to the attached drawings.

### BRIEF DESCRIPTION OF THE DRAWINGS

FIGS. 1A and 1B are schematic diagrams depicting a photoacoustic apparatus according to an embodiment;

FIG. 2 is a flow chart depicting processing performed by the photoacoustic apparatus according to the embodiment;

FIGS. 3A, 3B and 3C are diagrams depicting a method of setting a bright field reconstruction region and a dark field reconstruction region;

FIGS. 4A and 4B are diagrams depicting a method of generating a bright field image and a dark field image;

FIGS. 5A and 5B are diagrams depicting the principle of reducing noise according to the present invention; and

FIG. 6 is an example of an image that is displayed by the photoacoustic apparatus according to the embodiment.

### DESCRIPTION OF THE EMBODIMENTS

Preferred embodiments of the present invention will be described with reference to the drawings. Dimensions, materials, shapes and relative positions of the components described below can be appropriately changed depending on the configuration and various conditions of the apparatus to which the invention is applied. Therefore the following description is not intended to limit the scope of the present invention.

The present invention relates to a technique for detecting an acoustic wave that propagates from an object, and generating and acquire characteristic information inside the object. Therefore the present invention may be regarded as a photoacoustic apparatus or a control method thereof. Further, the present invention may be regarded as a program that causes an apparatus, which has such hardware resources as a CPU and a memory, to execute this method, or a non-transitory computer readable storage medium that stores the program.

Furthermore, the present invention may be regarded as an information processing apparatus or an information processing method that processes signals acquired by a photoacoustic apparatus or an object information acquiring apparatus.

The photoacoustic apparatus according to an embodiment of the present invention is an apparatus utilizing the photoacoustic effect, which irradiates light (electromagnetic wave) to an object, receives an acoustic wave generated inside the object, and acquires characteristic information on the object as image data. In this case, the characteristic information is information on characteristic values which are generated using receive signals obtained by receiving the photoacoustic wave, and which correspond to a plurality of positions inside the object respectively.

The characteristic information acquired by the photoacoustic measurement are values reflecting the absorption rates of the light energy. For example, the characteristic information includes a generation source of the acoustic wave generated by the light irradiation, the initial sound pressure inside the object, or the light energy absorption density or the absorption coefficient derived from the initial sound pressure, and the concentration of a substance constituting the tissue.

Such information as the concentration of a substance constituting the object is acquired based on the photoacoustic wave generated by lights having a plurality of different wavelengths. This information may be the oxygen saturation degree, a value determined by weighting the oxygen saturation degree with intensity (e.g., absorption coefficient), the total hemoglobin concentration, the oxyhemoglobin concentration or the deoxyhemoglobin concentration. This information may also be the glucose concentration, the collagen concentration, the melanin concentration, or the volume fraction of fat or water.

In the following embodiment, it is assumed that a photoacoustic imaging apparatus is used, which irradiates a light having a wavelength (selected assuming that the absorber is hemoglobin) to an object, which in turn acquires and images data on the distribution and shapes of blood vessels in the object, and data on the oxygen saturation distribution in the blood vessels.

Based on the characteristic information at each position inside the object, a two-dimensional or three-dimensional characteristic information distribution is acquired. The distribution data may be generated as image data. The characteristic information may be determined as distribution information at each position inside the object, instead of as numeric data. In other words, such distribution information as initial sound pressure distribution, the energy absorption density distribution, the absorption coefficient distribution and the oxygen saturation distribution may be determined.

The acoustic wave in the present description is typically an ultrasonic wave, including an elastic wave called a “sound wave” and a “photoacoustic wave”. An electric signal, which was converted from an acoustic wave by a probe or the like, is called an “acoustic signal”. Such phrases as ultrasonic wave or acoustic wave in this description, however, are not intended to limit the wavelengths of these elastic waves. An acoustic wave generated by the photoacoustic effect is called a “photoacoustic wave” or a “light-induced ultrasonic wave”. An electric signal, which originates from the photoacoustic wave, is called a “photoacoustic signal”. In this description, a photoacoustic signal includes both an analog signal and a digital signal. The distribution data is also called “photoacoustic image data” or “reconstructed image data”.

The photoacoustic apparatus according to this embodiment is an apparatus that generates information related to optical characteristics inside the object by irradiating a pulsed light to the object, and receiving a photoacoustic wave generated inside the object.

System Configuration

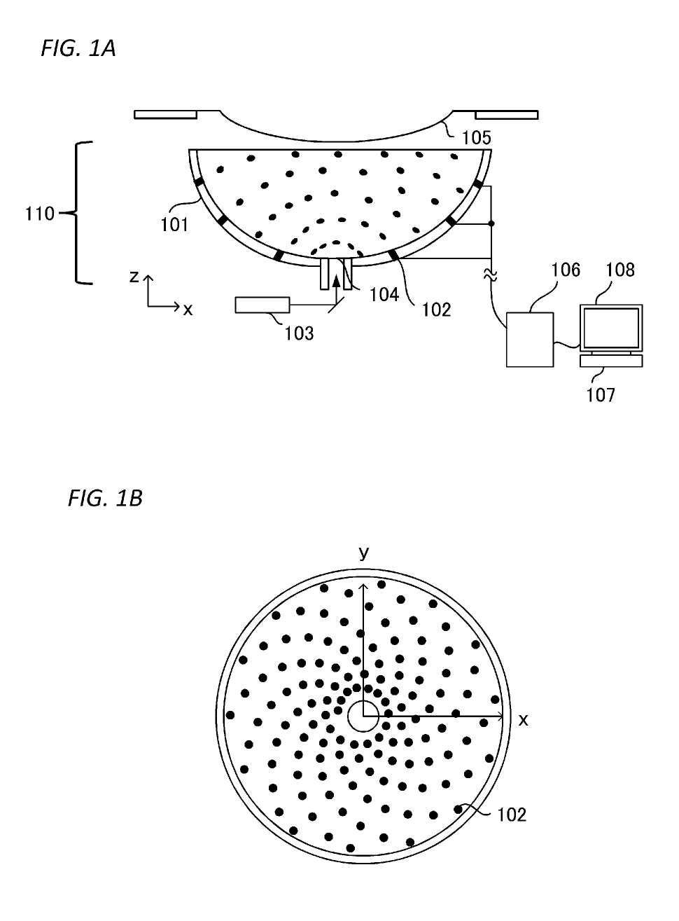

FIGS. 1A and 1B are diagrams depicting a configuration of the photoacoustic apparatus according to this embodiment. The photoacoustic apparatus according to this embodiment is constituted of a probe unit 110, a light irradiating unit 103, a holding member 105, a signal processing unit 106, a data processing unit 107 and a display device 108. The probe unit 110 includes a probe support member 101, a plurality of acoustic wave probes 102, and an opening 104.

FIG. 1A is a cross-sectional view of the probe unit 110, and FIG. 1B is a top view (in Z axis direction) of the probe unit 110.

The probe unit 110 is a unit that irradiates light to an object, and receives an acoustic wave generated from the object. The probe unit 110 is configured by disposing a plurality of (e.g., 512) acoustic wave probes 102 in a spiral on an inner surface of a hemispherical probe support member 101. Further, on the base of the probe support member 101, an opening 104, for the light emitted from the later mentioned light irradiating unit 103 to pass through, is created.

The probe support member 101 is an approximately hemispherical container that supports a plurality of acoustic wave probes 102. In this embodiment, the plurality of acoustic wave probes 102 are disposed on the hemispherical inner surface, and the opening 104 for the light to pass through is created at the base (pole) of the hemisphere. An acoustic matching material (e.g., water) may fill the inside of the hemisphere. To support these members, it is preferable that the probe support member 101 is made of a metal material having high mechanical strength, for example.

The acoustic wave probe 102 is a unit that receives an acoustic wave from inside the object, and converts the acoustic wave into an electric signal. The acoustic wave probe 102 is also called a probe, an acoustic wave detecting element, an acoustic wave detector, an acoustic wave receiver, or a transducer.

The acoustic wave generated from a living body is an ultrasonic wave in the 100 kHz to 100 MHz range, hence an element that can receive this frequency band is used for the acoustic wave probe 102. In concrete terms, a transducer using a piezoelectric phenomenon, a transducer using a resonance of light, a transducer using a change of capacitance or the like can be used.

It is preferable that the acoustic wave probe 102 has high sensitivity and a wide frequency band. In concrete terms, a piezoelectric element using lead zirconate titanate (PZT), a high polymer piezoelectric film material, such as polyvinylidene fluoride (PVDF), a capacitive micro-machine ultrasonic transducer (CMUT), and a Fabry-Perot interferometer, may be used. The acoustic wave probe 102, however, is not limited to these elements, but may be any element as long as the functions of the probe can be implemented.

In this embodiment, a single element CMUT, which has a 3 mm opening and 0.5 to 4 MHz band, is used for the acoustic wave probe 102. In the case of this configuration, the resolution of the apparatus is 0.5 mm. If the acoustic wave probe, of which frequency band includes a low frequency band, is used in this way, it can be prevented that the inside of a relatively thick blood vessel will look hollow and a cross-section of the blood vessel will look like a ring. The sampling frequency is 40 MHz, and a 2048 sampling is performed. The acquired data is signed 12-bit data.

The plurality of acoustic wave probes 102 are disposed in an array on the hemispherical surface such that the receiving directions of the elements are directed to the center of the curvature of the hemisphere. By disposing the plurality of acoustic wave probes 102 in this way, high resolution is implemented at the center of the curvature of the hemisphere.

The probe unit 110 can be moved in three dimensional directions by a scanning mechanism (not illustrated). Thereby the irradiation position of the light and the receiving position of the acoustic wave can be moved relative to the object. The scanning mechanism may have a guide mechanism, a drive mechanism and a scanning position sensor in three directions (X, Y and Z axes) respectively.

The light irradiating unit 103 is constituted of a light source which generates light (typically pulsed light) that is irradiated to the object, and an optical system which guides this light to the probe unit.

The light source is an apparatus that generates a pulsed light which is irradiated to the object. The light source may preferably be a laser light source because of the high power, but a light-emitting diode or flash lamp may be used instead of a laser. In the case of using a laser as the light source, various lasers, such as a solid-state laser, gas laser, dye laser and semiconductor laser can be used.

The wavelength of the pulsed light is preferably a specific wavelength with which the pulsed light is absorbed by a specific component out of the components constituting the object, and is a wavelength with which the light propagates into the object. In concrete terms, such a wavelength is at least 700 nm and not more than 1100 nm. The light in this range can reach relatively deep into a living body, hence information in a deep region of the object can be acquired.

To effectively generate the acoustic wave, the light must be irradiated in a sufficiently short time in accordance with the thermal characteristics of the object. When the object is a living body, about 10 to 50 nanoseconds is suitable for the pulse width of the pulsed light generated from the light source.

The timing of the light irradiation, the waveform, intensity and the like of the light are controlled by the later mentioned data processing unit 107.

In this embodiment, a titanium sapphire laser (wavelength: 800 nm) which is a solid-state laser, is used as the light source. By using a light source which can irradiate lights having a plurality of wavelengths, the absorption coefficient of each wavelength can be calculated, which makes calculation of the oxygen saturation degree possible.

The optical system is a member that transmits a pulsed light emitted from the light source. The light emitted from the light source is guided to the object by such optical components as a lens and a mirror, while being processing to have a predetermined light distribution profile, and is irradiated. It is also possible to propagate light by using such an optical waveguide as optical fibers.

The optical system may include such optical components as a lens, a mirror, a prism, an optical fiber, a diffusion plate, a shutter and a filter. As long as the light emitted from the light source can be irradiated to the object in a desired profile, any optical component may be used for the optical system. In terms of safety to a living body and increasing the diagnostic region, it is better to spread the light over a certain area, rather than condensing the light by a lens.

The holding member 105 is a member that holds the object. In this embodiment, the object is inserted in the Z axis direction from the positive side, and is held in the state of being in contact with the holding member 105. It is preferable that the holding member 105 is made of a material such as polyethylene terephthalate, which has the strength to support the object and the characteristics to transmit light and acoustic wave. If necessary, an acoustic matching material may fill the inside of the holding member 105.

The signal processing unit 106 (signal acquiring unit in the present invention) is a unit that amplifies the electric signal acquired by the acoustic wave probe 102, and converts the amplified electric signal into a digital signal.

The signal processing unit 106 may be constituted of an amplifier that amplifies a receive signal, an A/D converter that converts an analog receive signal into a digital signal, a memory that stores a receive signal (e.g., FIFO), and an arithmetic circuit (e.g., FPGA chip). The signal processing unit 106 may be constituted of a plurality of processors and arithmetic circuits.

The data processing unit 107 (region setting unit and generating unit in the present invention) is a unit that controls each component of the photoacoustic apparatus. For example, the data processing unit 107 commands control of the apparatus in general, such as controlling the light irradiation to the object, control of the reception of the acoustic wave and photoacoustic signal, and control of the movement of the probe unit.

The data processing unit 107 also acquires object information, such as the light absorption coefficient and the oxygen saturation degree inside the object, based on the signal converted into a digital signal (photoacoustic signal). In concrete terms, the initial sound pressure distribution in the three-dimensional object is generated from the collected electric signal.

The data processing unit 107 generates a three-dimensional light intensity distribution inside the object based on the information on the intensity of light which is irradiated to the object. The three-dimensional light intensity distribution can be acquired by solving the light diffusion equation based on the information on the two-dimensional light intensity distribution. Further, the absorption coefficient distribution inside the object can be acquired using the initial sound pressure distribution inside the object, generated from the photoacoustic signal and the three-dimensional light intensity distribution. Further, the oxygen saturation distribution inside the object can be acquired by computing the absorption coefficient distribution at a plurality of wavelengths.

The data processing unit 107 may have a function to perform the information processing required for calculating the light quantity distribution and acquiring optical coefficients in the background, and other desired processing, such as signal correction.

The data processing unit 107 may also acquire instructions on the change of measured parameters, the start/end of measurement, the selection of the image processing method, the storing of patient information and images, and the analysis of data.

The data processing unit 107 may be constituted of a computer having a CPU, RAM, non-volatile memory and control port. Control is performed by the CPU executing the program stored in the non-volatile memory. The data processing unit 107 may also be implemented by a general purpose computer, or by a dedicated workstation. The unit that performs the arithmetic function of the data processing unit 107 may be constituted of a processor (e.g., CPU, GPU) and an arithmetic circuit (e.g., FPGA chip). These units may be constituted of a plurality of processors and arithmetic circuits, instead of a single processor and single arithmetic circuit.

The unit which performs the storing function of the data processing unit 107 may be a non-transitory storage medium (e.g., ROM, magnetic disk, flash memory), or a volatile medium (e.g., RAM). The storage medium in which a program is stored is a non-transitory storage medium. This unit may be constituted of a plurality of storage media instead of one storage media. The unit which performs the control function of the data processing unit 107 may be constituted of an arithmetic element (e.g., CPU).

The display device 108 is a device that displays information acquired by the data processing unit 107 and the processed information thereof. The display device 108 may be a plurality of apparatuses, or a single device constituted of a plurality of display units which can display information in parallel. It is preferable that an apparatus used for the display device 108 is at least a 30 inch display which can display color at high resolution and has at least a 1000:1 contrast ratio.

Overview of Measurement

A method of measuring a living body, which is an object, by using the photoacoustic apparatus of this embodiment will be described.

First a pulsed light emitted from the light irradiating unit 103 is irradiated to the object via the optical system. When a part of the energy of the light which propagated inside the object is absorbed by a light absorber (e.g., blood), an acoustic wave is generated from this light absorber by thermal expansion. If cancer exists inside the living body, light is specifically absorbed by the newly generated blood vessels of the cancer, and an acoustic wave is generated. The photoacoustic wave generated inside the living body is received by the acoustic wave probe 102.

In this embodiment, the light irradiation and acquisition of the acoustic wave can be performed while changing the relative positional relationship between the probe support member 101 and the object by using the scanning mechanism. In other words, the photoacoustic signal can be acquired while irradiating light a plurality of times to different positions on the object.

The signal received by the acoustic wave probe 102 is converted by the signal processing unit 106, and is analyzed by the data processing unit 107. The analysis result is volume data, which represents the characteristic information inside the living body (e.g., initial sound pressure distribution, absorption coefficient distribution), which is converted to a two-dimensional image, and is then outputted via the display device 108.

An overview of the processing unique to the photoacoustic apparatus according to this embodiment will be described next.

Generally the sound pressure of the generated acoustic wave increases as the quantity of light irradiated to the object increases. In other words, as the S/N ratio increases, information having higher accuracy can be acquired.

However if a substance having the property of absorbing light (e.g., mole) exists in a position close to the surface of the object (e.g., skin), the acoustic wave generated from this position may be reflected and scattered, and interfere with the signal generated in another position. For example, an artifact, due to the reflection of the acoustic wave, may appear in a position deeper than the position where the light absorber exists, and in this case, the light absorber that should be observed in the position of the artifact may not be observed accurately.

Therefore in the photoacoustic apparatus according to this embodiment, when a photoacoustic signal corresponding to a light irradiated at a certain timing is acquired, the region on the object is divided into a region where light is irradiated at an intensity exceeding a predetermined value, and a region where light is irradiated at an intensity less than the predetermined value. The former is called a “bright field region”, and the latter is called a “dark field region” herein below.

The signal generated from a reconstruction region, which is set based on the bright field region (hereafter called “bright field reconstruction region”) and a signal generated from a reconstruction region which is set based on the dark field region (hereafter called “dark field reconstruction region”) are processed independently, whereby a plurality of photoacoustic images are generated.

The bright field reconstruction region is the first region in the present invention, and the dark field reconstruction region is the second region in the present invention.

An image that is reconstructed using a photoacoustic signal corresponding to the acoustic wave generated from the bright field reconstruction region (hereafter called “bright field image”, that is, the first reconstructed image in the present invention) has a high signal level, but the level of the interfering signal (noise) thereof, such as an artifact, is also high. On the other hand, an image that is reconstructed using a photoacoustic signal corresponding to the acoustic signal generated from the dark field reconstruction region (hereafter called “dark field image”, that is the second reconstructed image in the present invention) has a signal level lower than the bright field image, but the level of the interfering signal (noise) thereof is also lower. In other words, by comparing the bright field image and the dark field image, the user of the apparatus can easily identify noise and artifact.

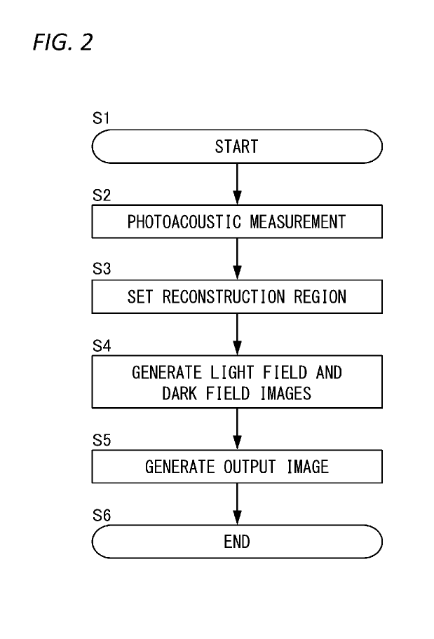

A concrete processing will be described with reference to FIG. 2.

First in step S1, preparation for measurement is performed. In this state, the object is inserted into the holding member 105 so as to contact with the holding member 105. To eliminate air from the propagation path of the acoustic wave, it is preferable that the object is in close contact with the holding member 105. An acoustic matching material (e.g., water) may be filled inside the holding member 105.

Then in step S2, the photoacoustic measurement is performed. In this step, the user of the apparatus inputs such parameters as a scanning range, and a center position of the scanning and wavelength of light to be irradiated, to the data processing unit 107, and instructs the start of measurement.

When the measurement starts, the scanning mechanism connected to the probe unit moves the probe support member 101 to a predetermined position in accordance with the inputted parameters. Then the light irradiating unit 103 irradiates light, the acoustic wave probe 102 receives the photoacoustic wave in synchronization with the light irradiation.

The irradiation of the light and the reception of the acoustic wave are performed at a plurality of positions (e.g., 1024 locations) on the object while moving the probe support member 101 in a spiral. The photoacoustic signal acquired thereby is temporarily stored in the memory of the signal processing unit 106.

If the light source that is used can output light having two wavelengths, the wavelength of the light may be switched alternately each time light is irradiated to the object while moving the probe unit.

Then in step S3, the photoacoustic apparatus determines the bright field region and the dark field region for the object, and acquires information on the corresponding bright field reconstruction region and dark field reconstruction region.

The bright field region and the dark field region are determined based on the distance from a position where the light axis of the light irradiated to the object intersects with the object. In other words, the bright field reconstruction region and the dark field reconstruction region are set based on the distance from a position where the light axis of the light irradiated to the object intersects with the object. In this embodiment, the photoacoustic measurement is performed while moving the irradiating position of the light, hence each time the light is irradiated, the bright field region and the dark field region also move. Therefore in this step, at each timing when light is irradiated to the object, the bright field region and the dark field region are determined based on the position of the light axis at this timing.

Concrete positions of the bright field region and the dark field region will be described.

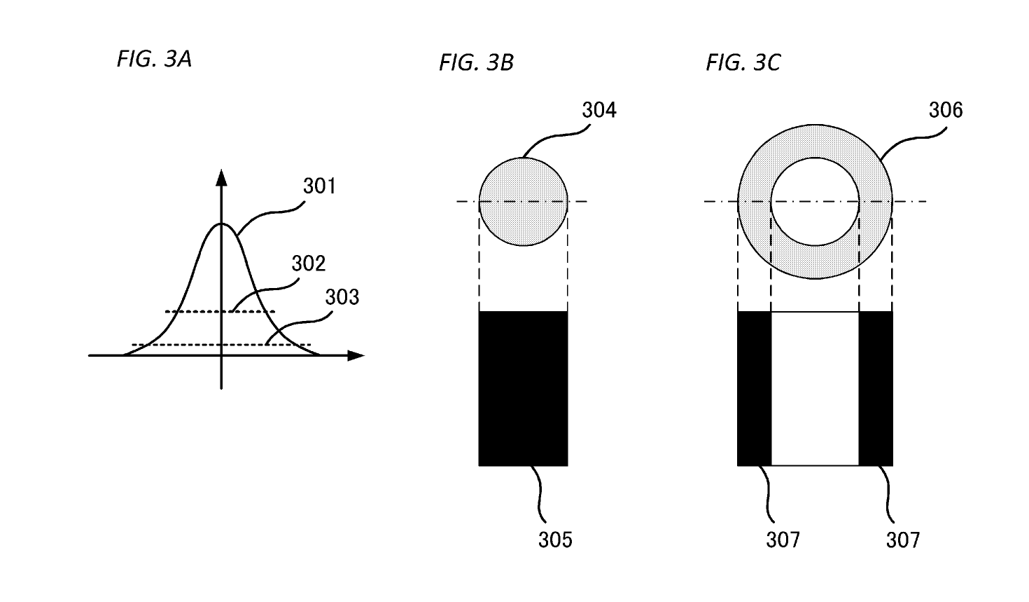

FIG. 3A is a diagram depicting a light quantity distribution when the light irradiated from the opening 104 reaches the surface of the object. The ordinate indicates the intensity of the light, and the abscissa indicates the distance on the XY plane. As indicated in FIG. 3A, the light intensity distribution 301 is a Gaussian distribution, where the intensity is the maximum at the center of the light axis. This light quantity distribution can be acquired by a power meter or the like in advance.

FIG. 3B is a diagram depicting a range of the bright field region 304. In this embodiment, the bright field region is the region in which the light quantity on the surface of the object exceeds a first light quantity 302 (first threshold in the present invention). For example, the bright field region can be determined as “a range in which the light quantity exceeds 30 mJ”. The ϕ40 mm range centered around the light axis on the surface of the holding member 105, for example, can be the bright field region.

The shapes and sizes of the bright field region and the dark field region may be calculated at each measurement, or may be appropriate data read from the data stored in advance in the memory of the signal processing unit 106.

The reference number 305 indicates the bright field reconstruction region corresponding to the bright field region. In this example, the bright field reconstruction region 305 corresponding to the bright field region is assumed to be a cylindrical region determined by extending the bright field region 304 in the depth direction.

FIG. 3C is a diagram depicting a range of the dark field region 306. In this embodiment, the dark field region is a region in which the light quantity on the surface of the object is lower than the first light quantity 302, and exceeds a second light quantity 303. The dark field region can be determined as “a range in which the light quantity exceeds 10 mJ and less than 30 mJ”, for example. The dark field reconstruction region corresponding to the dark field region is determined by removing the portion indicated by the reference number 305 from the cylinder determined by extending the dark field region 306 in the depth direction. The range is, for example, ϕ40 mm to ϕ60 mm.

Each reconstruction region may be cylindrical, but may be set in a truncated conical shape considering the diffusion of light in the object. In other words, the shape (diameter) may change in accordance with the depth from the surface of the object. The bright field reconstruction region may be, for example, a cylindrical region or a truncated conical region extending in the irradiating direction (light axis direction) of the light from the region on the object surface where light having a predetermined intensity is irradiated, or in the depth direction of the object. The dark field reconstruction region may be set in the same manner.

In the case of using a plurality of wavelengths, the bright field region and the dark field region may be set for each wavelength. For example, a bright field region and a dark field region may be set for a certain wavelength, and then a bright field or a dark field may be set for another wavelength by multiplying a predetermined ratio in accordance with the light quantity. In this example depicted in FIGS. 3A, 3B and 3C, the bright field region 304 and the dark field region 306 are set using a common threshold, but different thresholds may be used for the bright field region 304 and the dark field region 306 respectively.

Then in step S4, the reconstructed image is generated for the bright field reconstruction region and the dark field reconstruction region respectively. The measurement is performed while changing the irradiating position by spiral scanning, hence in this step, a plurality of reconstructed images are generated at each irradiation position, and are added.

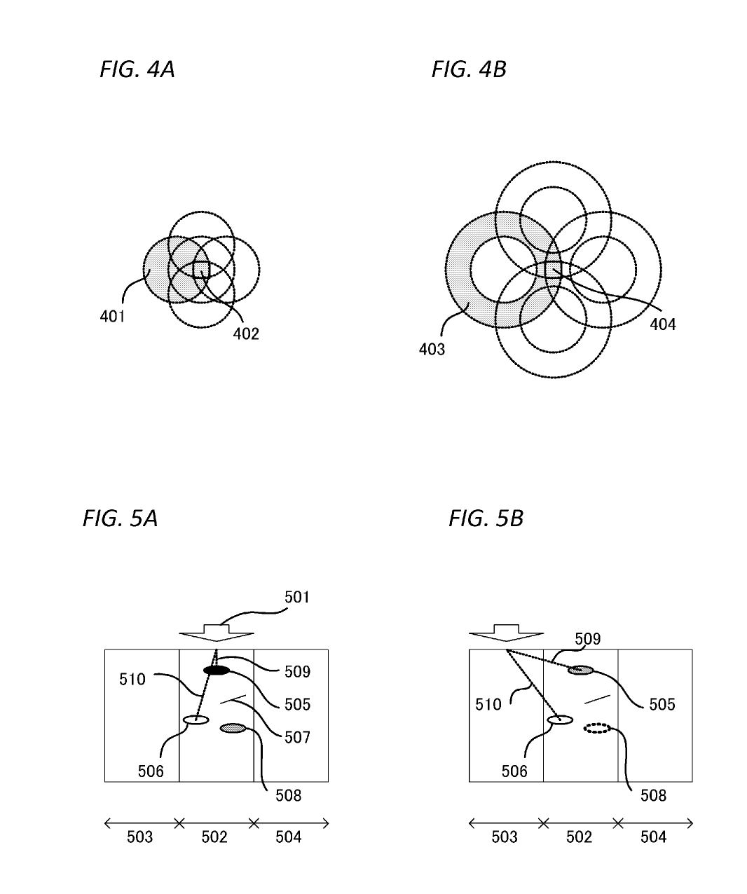

FIG. 4A is an example of generating a reconstructed image by using only a signal corresponding to an acoustic wave generated from the bright field reconstruction region. Here in order to generate the bright field reconstructed image corresponding to the region 402, five images acquired by performing five times of light irradiations (five images acquired by irradiating light to five different positions) are used.

FIG. 4B, on the other hand, is an example of generating a reconstructed image by using only a signal corresponding to an acoustic wave generated from the dark field reconstruction region. Here in order to generate the dark field reconstructed image corresponding to the region 404, four images acquired by performing four times of light irradiations (four images acquired by irradiating light to four different positions) are used.

The reconstructed image in a desired range can be acquired by adding the reconstructed images acquired at each light irradiation, and by dividing the added result by a number of times of additions at each voxel. By adding the reconstructed images, the S/N ratio of the image can be improved.

Thus in step S4, two types of reconstructed images (bright field image, dark field image) can be acquired for a desired region of the object.

Now the features of the bright field image and the dark field image will be described with reference to FIGS. 5A and 5B. FIGS. 5A and 5B are diagrams depicting cases when the measurement light 501 is irradiated to an object where an absorber 505 exists near the surface and an absorber 506 exists in a deep region.

FIG. 5A is an example when the measurement light 501 is irradiated to the region 502, and the region 502 becomes the reconstruction region. In this example, the region 502 becomes a bright field reconstruction region.

Here if a reflection layer 507, by which the acoustic wave is reflected, exists inside the object, the photoacoustic wave generated from the absorber 505 is reflected by the reflection layer 507, and the artifact 508 is generated.

In the case of this example, the optical path length 509, with respect to the absorber 505 near the surface, is short, hence a relatively strong acoustic wave is generated from the absorber 505.

FIG. 5B, on the other hand, is an example when the measurement light 501 is irradiated to the region 503, and the region 502 becomes the reconstruction region. In this example, the region 502 becomes a dark field reconstruction region.

In the case of this example, the optical path length 509, with respect to the absorber 505 on the surface, is relatively longer than the optical path length 510 with respect to the absorber 506 in a deep region compared with FIG. 5A. Therefore the acoustic wave generated from the absorber 505 becomes weaker than the case of FIG. 5A. As a result, the artifact 508 generated by reflection becomes relatively weak. Thus if reconstruction is performed for a dark field reconstruction region, the artifact becomes smaller than the case of performing reconstruction for the bright field reconstruction region.

Further, the change in the optical path length 510, with respect to the absorber 506 in the deep region, is small, hence visibility of the absorber 506 is not affected compared with the absorber 505. In other words, only the artifact can be considered to be reduced without dropping very much visibility of the absorber 506 located in the deep region of the object.

Returning to FIG. 2, description of the processing of the photoacoustic apparatus is continued.

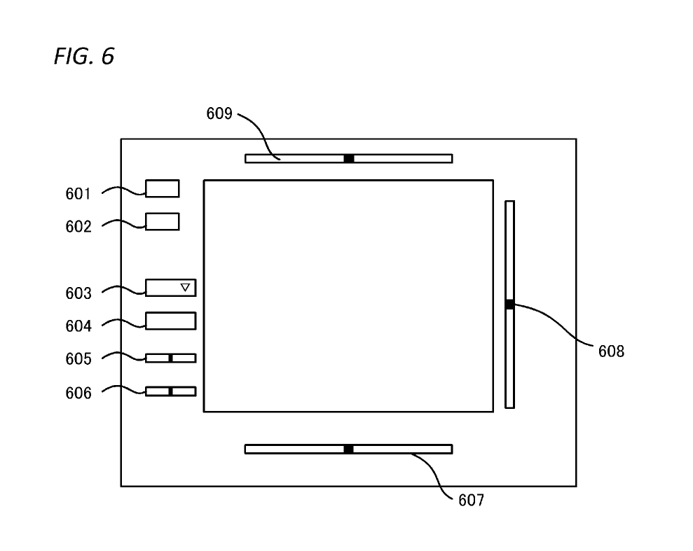

In step S5, the output image is generated based on the acquired bright field image and dark field image. FIG. 6 is an example of the user interface outputted to the display device.

In this embodiment, the combined reconstructed image is displayed in a window of the image display region 609. The bright field image and the dark field image that are used for the combined image can be selected using buttons 601 and 602. By pressing button 601, the folder opens and the desired data to be combined can be selected from this opened folder. This is the same for the button 602. The types of image that can be displayed here are: an initial sound pressure image, an absorption coefficient image, an oxygen saturation degree image and the like. The sectioning direction of the cross-section to be displayed can be set using a list box 603. Thereby a cross-section of the axial, sagittal or coronal direction, or all three cross-sections can be displayed in a window. In this way, images to be combined are selected using the buttons 601 and 602.

Further, a number of maximum value projection images (MIP), generated from a plurality of tomographic images, can be specified using a text box 604. By the MIP image, the intersections of the blood vessels and tumor can be more clearly seen. For example, only a part of the blood vessels can be seen in one image (thickness: 0.125 μm), but if the thickness of the MW is set to 20 mm in the depth direction, the blood vessels existing in about a 20 mm range from the surface of the breast can be displayed. Therefore a network of blood vessels can be observed. If the thickness of the MIP is decreased (e.g., set to 3 mm in the depth direction), on the other hand, the path flow of one blood vessel can be checked. In this case, the center coordinates of the cross-section to be displayed is specified using a slider 608. In other words, from a shallow portion to a deep portion can be checked by moving the slider 608 in the Z direction when the coronal image (XY plane) is on display. This means that the path flow of one blood vessel can be traced by moving the slider 608. In the case of an axial image (ZX image), the cross-section can be checked from head to tail direction by moving the slider 608, in the Y direction.

The brightness of the image can be adjusted by setting a window level, which specifies the center of the brightness of the image to be displayed, and setting a window width, which specifies the range of the brightness. Each of these values can be adjusted by moving the sliders 605 and 606. A wide window width is set to check general brightness. To check a region in a deep portion of the object where brightness is low, on the other hand, the window level is decreased and a narrow window width is set.

The mixing ratio of the bright field image and the dark field image can be adjusted by moving the slider 607. When the slider is set to the far left, the mixing ratio is a bright field image of 100%, and when the slider is set to the far right, the mixing ratio is a dark field image of 100%. In other words, the bright field image and the dark field image are multiplied by a predetermined weight that is set by the slider 607, and are then combined.

The bright field image is convenient to recognize the blood vessels near the surface, but the image contrast in the deep region becomes relatively low. The dark field image, on the other hand, can relatively improve the image contrast in a deep region where brightness is low. Therefore the blood vessels in a deep region can be more easily checked by increasing the ratio of the dark field image.

The ratio of the bright field image and the dark field image may be adjustable, or may be set in advance so that the images are displayed based on this ratio. Processing ends after step S6.

The bright field image, the dark field image and the combined image thereof may be displayed in parallel, or may be switched using the tab function. Further, an image generated by subtracting the bright field image or the dark field image from the combined image may be displayed so that a portion which changed considerably can be recognized.

As described above, the photoacoustic apparatus according to this embodiment sets the bright field reconstruction region and the dark field reconstruction region based on the intensity of light that is irradiated to the object, and an image is generated independently based on the acoustic wave generated from each region, and is provided to the user. Thereby noise and artifact can be easily recognized.

In this embodiment, a case of combining a weighted bright field image and dark field image was described, but combining images is not always necessary. For example, the bright field image and the dark field image may be outputted respectively to a plurality of display devices or windows (e.g., displayed side by side), allowing the user to compare images.

In this embodiment, an image that is reconstructed using only a signal corresponding to the acoustic wave generated from the bright field reconstruction region was described as a bright field image. However an image reconstructed by increasing the weight of a signal corresponding to an acoustic wave generated from the bright field reconstruction region, with respect to a signal corresponding to an acoustic wave generated from the dark field reconstruction region, may be handled as the bright field image. In the same manner, an image reconstructed by increasing a weight of a signal corresponding to an acoustic wave generated from the dark field reconstruction region, with respect to a signal corresponding to an acoustic wave generated from the bright field reconstruction region, may be handled as the dark field image.

Modification

Description on the embodiments is an example that describes the present invention, and the present invention can be carried out by appropriately changing or combining the above embodiments within a scope that does not depart from the essence of the invention.

For example, the present invention may be carried out as a photoacoustic apparatus that includes at least a part of the above mentioned units. The present invention may also be carried out as an information processing apparatus which does not include a unit that performs measurement of the object. In other words, this information processing apparatus is an apparatus that receives the photoacoustic signal from outside, and performs processing.

Furthermore, the present invention may be carried out as an information processing method that includes at least a part of the above mentioned processing. The above processing and units may be freely combined within a scope that does not generate technical inconsistencies.

In the description of the embodiments, the display device 108 was described as an example of a unit that displays an image, but the display device that provides an interface for operation and a display device that provides a photoacoustic image may be separate devices.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-212930, filed on Nov. 2, 2017, which is hereby incorporated by reference herein in its entirety.

What is claimed is:

1. An information processing apparatus, comprising:
a signal acquiring unit configured to acquire a photoacoustic signal, which has been obtained based on an acoustic wave generated from an object by irradiating light to different positions on the object for a plurality of times;
a region setting unit configured to set a first region and a second region inside the object, based on a distance from a position at which a light axis of the light intersects with the object; and
a generating unit configured to generate a first reconstructed image by using a photoacoustic signal corresponding to an acoustic wave generated from the first region, and to generate a second reconstructed image by using a photoacoustic signal corresponding to an acoustic wave generated from the second region.

2. The information processing apparatus according to claim 1, further comprising a combining unit configured to combine the first reconstructed image and the second reconstructed image.

3. The information processing apparatus according to claim 2, wherein the combining unit performs weighted addition on the first reconstructed image and the second reconstructed image.

4. The information processing apparatus according to claim 1, wherein the generating unit generates an image in which the first reconstructed image and the second reconstructed image are disposed side by side.

5. The information processing apparatus according to claim 1, wherein the region setting unit sets the first region and the second region, based on a light quantity of light irradiated to a surface of the object.

6. The information processing apparatus according to claim 5, wherein the first region is set based on a region on the surface of the object where the light quantity of the irradiated light exceeds a first threshold, and the second region is set based on a region on the surface of the object where the light quantity of the irradiated light is less than the first threshold.

7. The information processing apparatus according to claim 6, wherein the first region is a truncated conical region a diameter of which changes in accordance with a depth from the surface of the object.

8. The information processing apparatus according to claim 1, wherein the region setting unit sets the first region and the second region for each wavelength of the light irradiated to the object.

9. An information processing method, comprising:
a signal acquiring step of acquiring a photoacoustic signal, which has been obtained based on an acoustic wave generated from an object by irradiating light to different positions on the object for a plurality of times;
a region setting step of setting a first region and a second region inside the object based on a distance from a position at which a light axis of the light intersects with the object; and
a generating step of generating a first reconstructed image by using a photoacoustic signal corresponding to an acoustic wave generated from the first region, and generating a second reconstructed image by using a photoacoustic signal corresponding to an acoustic wave generated from the second region.

10. The information processing method according to claim 9, further comprising a combining step of combining the first reconstructed image and the second reconstructed image.

11. The information processing method according to claim 10, wherein, in the combining step, weighted addition on the first reconstructed image and the second reconstructed image is performed.

12. The information processing method according to claim 9, wherein, in the generating step, an image, in which the first reconstructed image and the second reconstructed image are disposed side by side, is generated.

13. The information processing method according to claim 9, wherein, in the region setting step, the first region and the second region are set based on a light quantity of light irradiated to a surface of the object.

14. The information processing method according to claim 13, wherein the first region is set based on a region on the surface of the object where the light quantity of the irradiated light exceeds a first threshold, and the second region is set based on a region on the surface of the object where the light quantity of the irradiated light is less than the first threshold.

15. The information processing method according to claim 14, wherein the first region is a truncated conical region a diameter of which changes in accordance with a depth from the surface of the object.

16. The information processing method according to claim 9, wherein, in the region setting step, the first region and the second region are set for each wavelength of the light irradiated to the object.
